(19) United States
(12) Patent Application Publication
(10) Pub. No.: US 2024/0193468 A1
(43) Pub. Date: Jun. 13, 2024

(54) FEDERATED LEARNING FOR MEDIA CONTENT RECOMMENDATION

(71) Applicant: Lemon Inc., Grand Cayman (KY)

(72) Inventor: Haipeng GAO, Culver City, CA (US)

(21) Appl. No.: 18/077,410

(22) Filed: Dec. 8, 2022

(51) Int. Cl. G06N 20/00

(52) U.S. Cl. CPC G06N 20/00

(57) ABSTRACT

A method is proposed for media content recommendation. In the method, a client device obtains a first version of a machine learning model for media content recommendation from a server. A first set of media contents is recommended based on local information of the client device according to the first version of the machine learning model. An update to the machine learning model is determined based on respective interactions of the user with the first set of media contents. The client device provides the update to the server.

### FIELD

The present disclosure generally relates to the field of computer, and more specifically, to methods, devices, and computer program products for federated learning for media content recommendation.

### BACKGROUND

Nowadays, more and more applications are designed to provide users with various services. Users can perform various operations on the application. For example, users can view various media contents (such as images, videos, audio, etc.) via an application. To this end, the application may recommend the users with media contents by using a machine learning (ML) model. Therefore, it is desired for the ML model to recommend media contents which the users are really interest of.

### SUMMARY

In a first aspect of the present disclosure, there is provided a method for media content recommendation. In the method, a first version of a machine learning model for media content recommendation is obtained from a server. A first set of media contents is recommended based on local information of the client device according to the first version of the machine learning model. An update to the machine learning model is determined based on respective interactions of the user with the first set of media contents. The update is provided to the server.

In a second aspect of the present disclosure, there is provided a method for media content recommendation. In the method, a first version of a machine learning model for media content recommendation is provided to a plurality of client devices. Updates to the machine learning model are obtained from the plurality of client devices. An update from a client device is determined based respective interactions of a user with a first set of media content recommended by the first version. The first version is updated to a second version of the machine learning model based on the updates.

In a third aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a fourth aspect of the present disclosure, there is provided an electronic device. The electronic device comprises: a computer processor coupled to a computer-readable memory unit, the memory unit comprising instructions that when executed by the computer processor implements a method according to the first aspect of the second disclosure.

In a fifth aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

In a sixth aspect of the present disclosure, there is provided a computer program product, the computer program product comprising a computer readable storage medium having program instructions embodied therewith, the program instructions executable by an electronic device to cause the electronic device to perform a method according to the second aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the more detailed description of some embodiments of the present disclosure in the accompanying drawings, the above and other objects, features, and advantages of the present disclosure will become more apparent, wherein the same reference generally refers to the same components in the embodiments of the present disclosure.

FIG. 1 illustrates an example environment in which example embodiments of the present disclosure can be implemented;

FIG. 2 illustrates a diagram of interactions between devices according to embodiments of the present disclosure;

FIG. 3 illustrates an example flowchart of a method for media content recommendation according to some embodiments of the present disclosure;

FIG. 4 illustrates an example flowchart of a method for media content recommendation according to some embodiments of the present disclosure; and

FIG. 5 illustrates a block diagram of a computing device in which various embodiments of the present disclosure can be implemented.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various embodiment of the present disclosure, the user should be informed of the type, scope of use, and use scenario of the information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's information. Therefore, the user may independently choose, according to the prompt information, whether to provide the information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

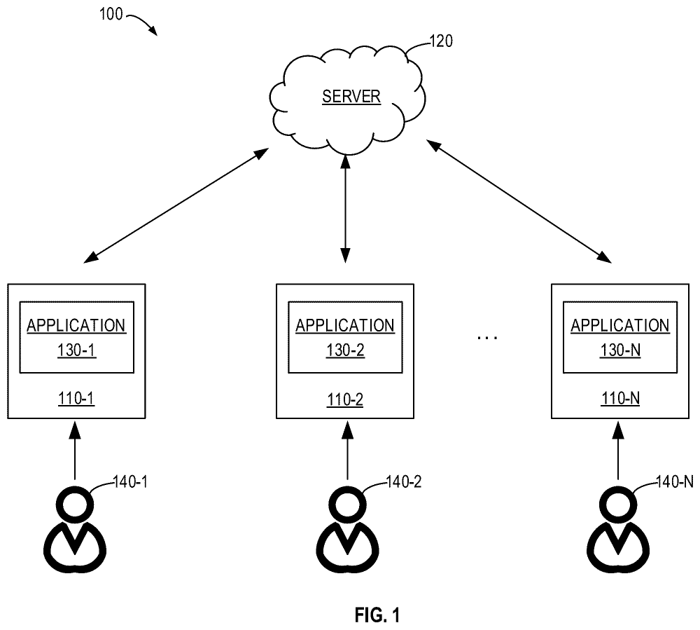

FIG. 1 illustrates an example environment 100 in which example embodiments of the present disclosure can be implemented. The environment 100 includes client devices 110-1, 110-2, . . . , 110-N, which may be collectively referred to as “client devices 110” or individually referred to as “client device 110”, where N is an integer. The environment 100 also includes a sever 120. Each client device has an application installed thereon, for example, shown as applications 130-1, 130-2, . . . , 130-N, which may be collectively referred to as “applications 130” or individually as “application 130”. For example, the application 130-1 is stalled on the client device 110-1. The environment 100 also includes users 140-1, 140-2, . . . , 140-N, which are collectively referred to as “users 140 or individually as “user 140”. The user 140 can interact with the application 130 via the client device 110 and/or a device attached to the client device 110. For example, the user 140-1 may interact with the application 130-1 via the client device 110-1.

The application 130 may be a social media application or content sharing application that is capable of providing to user 140 at least services related to consumption of media content, including selection, edition, posting of media content and the like. In the context of the present disclosure, “media content” may include a variety of forms, including, but not limited to, images (such as captured photos, composite images, screenshots), video, audio, and the like. In some embodiments, the application 130 may also provide other services related to the consumption of media content, such as viewing, commenting, forwarding, creating (e.g., photographing and/or editing) and the like.

The client device 110 may be any type of mobile terminal, fixed terminal, or portable terminal, including a mobile phone, a desktop computer, a laptop computer, a notebook computer, a netbook computer, a tablet, a media computer, a multimedia tablet, a personal communication system (PCS) device, a personal navigation device, a personal digital assistant (PDA), an audio/video player, a camera, a positioning device, a television receiver, a radio broadcast receiver, an e-book device, a gaming device, or any combination of the foregoing, including accessories and peripherals for these devices or any combination thereof. In some embodiments, the client device 110 can also support any type of user-specific interface (e.g., “wearable” circuitry, etc.).

In some embodiments, the client device 110 may communicate with the server 120 to enable the provisioning of services to the application 130. The server 120 is a computing system/server of various types capable of providing computing power, including but not limited to mainframes, edge computing nodes, computing devices in a cloud environment, and the like. It should be understood that the structure and functionality of the environment 100 is described for illustration purposes only, without implying any limitation on the scope of the present disclosure. It is noted that the number of devices shown in FIG. 1 is only an example not limitation.

As mentioned above, ML models have been used in media content recommendation. With the development of social media, there may be vast amount of media information. In the scenario of recommending media contents to users, related media content may be selected from billions of media contents. It is a challenge for the ML model to select media contents for recommendation from such huge amount of media contents. To recommend media contents which a user is really interest of, the ML model may use information of the user, for example, the age, the gender, education background, preference, etc. of the user. Accordingly, training of the ML model may need such information from different users to improve performance of the ML model. However, such information is private and sensitive for the user and the user might not wish the information to be spread to a remote device, for example, to a server training the ML model.

Meanwhile, federated learning has been proposed. Federated learning is a machine learning technique that trains an algorithm across multiple decentralized edge devices holding local data samples, without exchanging them. This approach stands in contrast to conventional centralized machine learning techniques where all the local datasets are uploaded to one server, as well as to more classical decentralized approaches which often assume that local data samples are identically distributed.

Embodiments of the present disclosure propose solutions on federated learning for media content recommendation. According to embodiments of the present disclosure, the client device obtains an ML model for media content recommendation from a server. The client device trains the ML model based on user interactions with media contents recommended by the ML model. The client device provides an update related to the ML model to the server. The server updates the machine learning based on the update from one or more client devices.

In embodiments of the present disclosure, the ML model is trained using actual interaction data of users without leakage of the data. In this way, the performance of the ML model can be improved while ensuring security of data of the user. Moreover, user experience can also be improved.

Example embodiments of the present disclosure will be described in detail below with reference to the accompanying drawings.

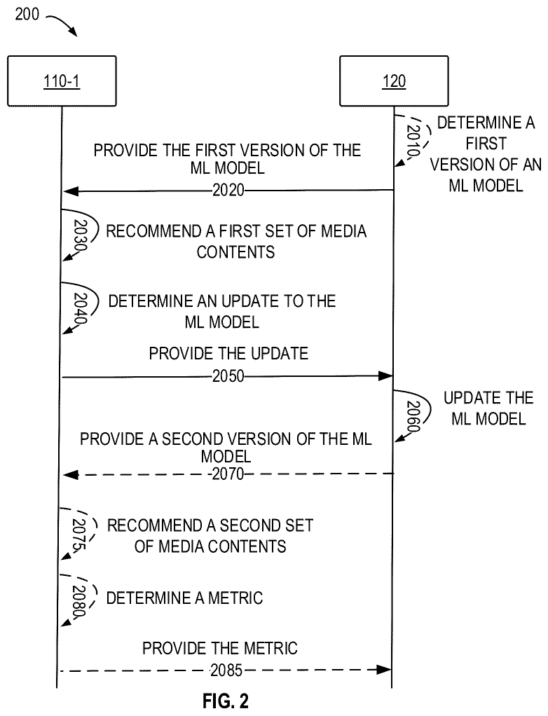

Reference is now made to FIG. 2, which shows a signaling chart 200 for media content recommendation according to some example embodiments of the present disclosure. As shown in FIG. 2, the signaling chart 200 involves the client device 110-1, and the server 120. For the purpose of discussion, reference is made to FIG. 1 to describe the signaling chart 200. Although one client device 110-1 and one server 120 are illustrated in FIG. 2, it would be appreciated that there may be a plurality of client devices performing similar operations as described with respect to the client device 110-1 below and a plurality of servers performing similar operations as described with respect to the server 120 below.

The server 120 may determine (2010) a first version of an ML model for media content recommendation. In the following, the first version of the ML model may be represented as m_{j}, where m denotes the ML model and j denotes the j-th turn of training iteration. In some embodiments, the first version may be an initial version of the ML model which is trained based on historical data related to media content recommendation or which is a pretrained model. The ML model may be implemented in any suitable machine learning algorithm, including neural network or classic ML model.

The server 120 provides (2020) the first version of the ML model (i.e., m_{j}) for media content recommendation to a plurality of client devices 110. Accordingly, the client device 110-1 obtains the first version of the ML model from the server 120. In some embodiments, the server 120 may autonomously provide the first version of the ML model. Alternatively, the server 120 may provide the first version of the ML model based on request(s) from one or more client devices.

In some embodiments, the sever 120 may reduce the number of candidate media contents related to recommendation. For example, the sever 120 may reduce billions of candidate media contents to thousands/hundreds of candidate media contents using another ML model, for example, a classic ML model. In some embodiments, the classic ML model may be a logistic regression model. Alternatively, the classic ML model may be an Xgboost model.

The client device 110-1 recommends (2030) one or more media contents (referred to as “a first set of media contents” or “recommended media contents” hereinafter) to the user 140-1 based on local information of the client device 110-1 according to the first version of the ML model. The local information may include a user profile of the user 140-1. For example, the local information may include one or more of the followings associated with the user: age, gender, education background, preference, habits, or hobbies, etc. It should be understood that, before collecting the local information (for example, information about the user), the user should be informed of the type, scope of use, and use scenario of the information involved in the present disclosure in an appropriate manner in accordance with relevant laws and regulations, and the user's authorization should be obtained. By way of example, if the user 140-1 is a fan of science fiction, the client device 110-1 may recommend one or more media contents associated with the science fiction according to the first version of the ML model. Alternatively, or in addition, the information may include historic interactions of the user 140-1 with media contents. For example, if the user 140-1 has viewed videos for football previously, the client device 110-1 may recommend the media contents related to world cup.

The recommended media contents may be selected from candidate media contents by the ML model. In some embodiments, as mentioned above, the server 120 may reduce the number of the candidate media contents based on the other ML model, for example, the classic ML model. In this case, the server 120 may provide information about a first number of candidate media contents that is selected from a second number of candidate media contents by the server 120. The client device 110-1 may feed the local information to the ML model to select the first set of media contents from the first number of candidate media contents. The client device 110-1 may present an indication of the first set of media contents to the user 140-1.

By way of example, the sever 120 may select 1000 candidate media contents related to sports from billions of candidate media contents based on the classic ML model. The information about the 1000 candidate media contents related to sports may be transmitted to the client device 110-1 from the server 120. The ML model is fed with the local information which indicates that the user 140-1 has viewed videos for football previously. Accordingly, one or more media contents related to football may be selected from the 1000 candidate media contents related to sports by the ML model. The client device 110-1 may present the indication of the one or more media contents related to football to the user 140-1.

The client device 110-1 determines (2040) an update to the ML model based on respective interactions of the user 140-1 with the first set of media contents. If the ML model is based on neural network, the update may include gradients for parameters of the ML model, respectively. In this case, the update may be represented by d_{i,j} where i represents the i-th client device and j represents the j-th turn of training iteration. Alternatively, if the ML model is based on a classic model, the update may include any other suitable data, for example, information entropy for a decision tree.

The interactions of the user 140-1 may include any behaviors of the user 140-1 with respect to the recommended media contents. For example, the interaction may include the user 140-1 commenting the media content(s) from the first set of media contents. Alternatively, or in addition, the interaction may include the user 140-1 forwarding/sharing the media content(s) from the first set of media contents. The interaction may also include the user 140-1 liking the media content(s). The interaction may include the user 140-1 skipping the media content(s) or viewing the media content(s) for a very short duration (for example, several seconds). It is noted that interactions are not limited to the above-mentioned types of interactions.

In some embodiments, the client device 110-1 may assign a label to a candidate media content in the first set of media contents. The label may correspond to the interaction of the user 140-1 with the candidate media content. In this case, the label may indicate a degree of interest of the user in the candidate media content. For example, if the user 140-1 likes a media content A and forwards a media content B, a label assigned to the media content A may indicate a medium level of interest in the media content A and a label assigned to the media content B may indicate a high level of interest in the media content B.

The client device 110-1 may determine a difference between the label and a prediction of the candidate media content by the first version of the ML model. By way of example, the ML model may predict that a high level of interest in the media content A. The client device 110-1 may determine the difference between the label assigned to the media content A indicating the medium level of interest and the prediction indicating the high level of interest in the media content A. The client device 110-1 may determine the update based on respective differences determined for the first set of media contents.

The label may be determined based on different granularities. In some embodiments, the label may have a relative coarse granularity. For example, the label may be selected from a first label corresponding to a positive user interaction and a second label corresponding to a negative user interaction. By way of example, if the user 140-1 skips or just gives a glance at a media content C by quickly sweeping the screen of the client device 110-1, the second label may be assigned to the media content C. If the user 140-1 views a media content D, the first label may be assigned to the media content D.

Alternatively, in some embodiments, the label may be determined based on a finer granularity. The label may be selected from two or more candidate labels. The candidate labels may include a third label corresponding to tagging a media content positively. As an example, if the user 140-1 likes (such as, thumb up) a media content E, the third label may be assigned to the media content E. The candidate labels may include a fourth label corresponding to spreading of a media content. For example, if the user 140-1 forwards the media content E or shares the media content E with another user, the fourth label may be assigned to the media content E. The candidate labels may include a fifth label corresponding to commenting a media content. For example, if the user 140-1 comments the media content E, the fifth label may be assigned to the media content E. The candidate labels may include a sixth label corresponding to ignoring of a media content. By way of example, if the user 140-1 skips the media content E or view the media content E for only several seconds, the sixth label may be assigned to the media content E. The candidate labels may include a seventh label corresponding to tagging a media content negatively. For example, if the user 140-1 dislikes (such as, thumb down) the media content E, the seventh label may be assigned to the media content E. It is noted that the above labels are given as examples without any limitation. The label may also include any proper types of labels.

In some embodiments, once the user 140-1 turns off a media content provision application utilizing the machine learning model (for example, the application 130-1), the training of the ML model may be triggered. In this way, training of the ML model would not degrade user experience for the media content provision application. In some embodiments, the ML model may be trained based on the above-mentioned difference between the label and a prediction of the candidate media content by the first version of the ML model, after the application 130-1 is turned off. For example, if 20 media contents are recommended to the user 140-1 based on the ML model, the user 140-1 may interact with 8 media contents from the 20 media contents and skip the other 12 media contents. In this case, the ML model may be locally trained based on the determined differences related to the 20 media contents. The 8 media contents are positive samples, and the other 12 media contents are negative samples.

The client device 110-1 provides (2050) the update (for example, d_{i,j}) to the server 120. In some embodiments, to ensure the security of data, the update may be encrypted. For example, the client device 110-1 may encrypted the update with a private key of the client device 110-1.

The server 120 obtains a plurality of updates from the plurality of client devices 110, respectively. For example, the server 120 may collect a plurality of gradients related to the first version of the ML from the client devices 110.

The server 120 updates (2060) the first version to a second version of the ML model based on the updates. In some embodiments, the server 120 may process the collected gradients. For example, the server may determine an averaged value of the collected gradients. The second version of the ML model may be determined based on the averaged value of the collected gradients. Specifically, the values of the parameters of the ML model may be updated based on the averaged value of the collected gradients. The second version of the ML model may be represented as “m_{j+1}.”

The server 120 may provide (2070) the second version of the ML model (i.e., m_{j+1}) to the plurality of client devices 110. Accordingly, the client device 110-1 may obtain the second version of the ML model from the server 120. In some embodiments, the second version of the ML model may be provided to all client devices 110 that also obtain the first version of ML model. Alternatively, the second version of the ML model may be provided to a subset of client devices that obtain the first version of the ML model. For example, both the client devices 110-1 and 110-2 may obtain the first version of ML model, while only the client device 110-1 may obtain the second version of the ML model.

In some embodiments, the client device 110-1 may determine another update to the second version of the ML model to further train the ML model. The procedure is similar as described with respect to the first version above and thus is not repeated.

Alternatively, in some embodiments, testing of the ML model may be performed. Specifically, the client device 110-1 may recommend (2075) one or more media contents (referred to as “a second set of media contents” hereinafter) to the user 140-1 based on local information of the client device according to the second version of the ML model. As mentioned above, the local information may include a user profile of the user 140-1. Alternatively, or in addition, the local information may include historic interactions of the user 140-1. For example, if the user 140-1 has viewed videos for football previously, the client device 110-1 may recommend the media contents related to a specific team according to the second version of the ML model. Similarly, the client device 110-1 may also assign labels to the second set of media contents.

The client device 110-1 may determine (2080) a metric for evaluating the machine learning model based on respective interactions of the user 140-1 with the second set of media contents. The metric may be of any suitable type. In some embodiments, the metric may be the difference between the assigned label and the prediction of the second version of the ML model. For example, if 20 media contents are recommended to the user 140-1 based on the second version of the ML model, the user 140-1 may interact with 15 media contents from the 20 media contents and skip the other 5 media contents. By way of example, the predictions of the 20 media contents by the first version of the ML model are the first label that corresponds to positive user interactions. The 15 media contents are assigned with the first label, as the user 140-1 interacts with the 15 media contents. However, since the user 140-1 skipped 5 media contents, the 5 media contents are assigned with the second label corresponding to negative user interactions, which is different from the prediction of these 5 media contents. In this situation, the metric may indicate the differences between the predicated first label of the 5 media contents and the assigned second label of the 5 media contents and the consistencies of assigned labels and predicted labels for the 15 media contents. It is noted that the metric may comprise any proper parameters that indicate the performances of the second version of the ML model.

The client device 110-1 may provide (2085) the metric to the server 120. The server 120 may obtain a plurality of metrics from the plurality of client devices 110, respectively. These metrics can indicate the performances of the second version of the ML model. Accordingly, the client device 110-1 may determine whether to terminate training of the ML model.

According to embodiments of the present disclosure, a machine learning model may be trained based on user interactions at the client device. In this way, the performance of the machine learning model can be improved while ensuring security of data of the user.

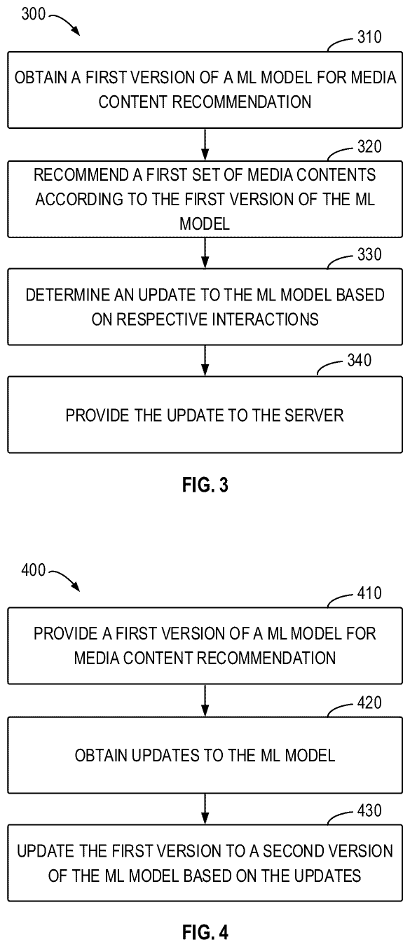

The above paragraphs have described details for the media content recommendation. According to some embodiments of the present disclosure, a method is provided for media content recommendation. Reference will be made to FIG. 3 for more details about the method. FIG. 3 illustrates an example flowchart of a method 300 for media content recommendation according to some embodiments of the present disclosure. The method 300 may be implemented at a client device, for example, the client device 110.

At a block 310, a first version of a ML model for media content recommendation is obtained from a server. At block 320, a first set of media contents is recommended based on the local information of a client device according to the first version of the ML model. At block 330, an updated to the ML model is determined based on respective interactions of the user with the first set of media contents. At block 340, the update is provided to the server.

In some embodiments of the present disclosure, determining the update to the ML model may comprise: for a given media content in the first set of media contents, assigning, to the given media content, a label corresponding to an interaction of the user with the given media content, the label indicating a degree of interest of the user in the given media content; determining a difference between the label and a prediction of the given media content by the first version of the ML model; and determining the update based on respective differences determined for the first set of media contents.

In some embodiments of the present disclosure, the label may be selected from the following: a first label corresponding to a positive user interaction, a second label corresponding to a negative user interaction.

In some embodiments of the present disclosure, the label may be selected from two or more of the following: a third label corresponding to tagging a media content positively, a fourth label corresponding to spreading of a media content, a fifth label corresponding to commenting a media content, a sixth label corresponding to ignoring a media content, a seventh label corresponding to tagging a media content negatively.

In some embodiments of the present disclosure, determining the difference may be response to turning off a media content provision application utilizing the ML model.

In some embodiments of the present disclosure, recommending the first set of media contents may comprise: obtaining, from the server, information concerning a first number of candidate media contents, the first number of candidate media contents being selected from a second number of candidate media contents; selecting the first set of media contents from the first number of candidate media contents by feeding the local information to the ML model; and presenting an indication of the first set of media contents.

In some embodiments of the present disclosure, the method may also comprise obtaining, from the server, a second version of the ML model, the second version being updated from the first version at least based on the update and a further update provided by a further client device.

In some embodiments of the present disclosure, the method may also comprise recommending, based on the local information, a second set of media contents according to the second version of the ML model; determining a metric for evaluating the ML model based on respective interactions of the user with the second set of media contents; and providing the metric to the server.

According to some embodiments of the present disclosure, an apparatus is provided for media content recommendation. The apparatus comprises: an obtaining module configured to obtain a first version of a ML model for media content recommendation; a recommending module configured to recommend, based on the local information of a client device, a first set of media contents according to the first version of the ML model; a determining module configured to determine an update to the ML model based on respective interactions of the user with the first set of media contents; and a providing module configured to provide the update to the server. Further, the apparatus may comprise other units for implementing other steps in the above method.

According to some embodiments of the present disclosure, an electronic device is provided for implementing the above method. The electronic device comprises: a computer processor coupled to a computer-readable memory unit, the memory unit comprising instructions that when executed by the computer processor implements a method for media content recommendation. The method comprises: obtaining, from a server, a first version of a ML model for media content recommendation; recommending, based on the local information of the electronic device, a first set of media contents according to the first version of the ML model; determining an update to the ML model based on respective interactions of the user with the first set of media contents; and providing the update to the server.

In some embodiments of the present disclosure, determining the update to the ML model comprises: for a given media content in the first set of media contents, assigning, to the given media content, a label corresponding to an interaction of the user with the given media content, the label indicating a degree of interest of the user in the given media content; determining a difference between the label and a prediction of the given media content by the first version of the ML model; and determining the update based on respective differences determined for the first set of media contents.

In some embodiments of the present disclosure, the label is selected from the following: a first label corresponding to a positive user interaction, a second label corresponding to a negative user interaction.

In some embodiments of the present disclosure, the label is selected from two or more of the following: a third label corresponding to tagging a media content positively, a fourth label corresponding to spreading of a media content, a fifth label corresponding to commenting a media content, a sixth label corresponding to ignoring a media content, a seventh label corresponding to tagging a media content negatively.

In some embodiments of the present disclosure, determining the difference is response to turning off a media content provision application utilizing the ML model.

In some embodiments of the present disclosure, recommending the first set of media contents comprises: obtaining, from the server, content information concerning a first number of candidate media contents, the first number of candidate media contents being selected from a second number of candidate media contents; selecting the first set of candidate media contents from the first number of candidate media contents by feeding the local information to the ML model; and presenting an indication of the first set of media contents.

In some embodiments of the present disclosure, the method further comprises obtaining, from the server, a second version of the ML model, the second version being updated from the first version at least based on the update and a further update provided by a further client device.

In some embodiments of the present disclosure, the method further comprises recommending, based on the local information, a second set of media contents according to the second version of the ML model; determining a metric for evaluating the ML model based on respective interactions of the user with the second set of media contents; and providing the metric to the server.

According to some embodiments of the present disclosure, a computer program product, the computer program product comprising a computer readable storage medium having program instructions embodied therewith, the program instructions executable by an electronic device to cause the electronic device to perform the method 300.

FIG. 4 illustrates an example flowchart of a method 400 for media content recommendation according to some embodiments of the present disclosure. The method 400 may be implemented at a server, for example, the server 120.

At block 410, a first version of a ML model for media content recommendation is provided to a plurality of client devices. At block 420, updates to the ML model are obtained from the plurality of client devices, respectively. An update from a client device is determined based respective interactions of a user with a first set of media content recommended by the first version. At block 430, the first version is updated to a second version of the ML model based on the updates.

In some embodiments of the present disclosure, the method further comprises providing the second version of the ML model to at least one client device of the plurality of client devices.

In some embodiments of the present disclosure, the method further comprises: obtaining, from a client device of the plurality of client devices, a metric for evaluating the ML model, the metric being determined based on respective interactions of the user with a second set of media contents recommended by the second version of the ML model.

In some embodiments of the present disclosure, the method further comprises: selecting a first number of candidate media contents from a second number of candidate media contents; and providing, to the plurality of client devices, content information concerning the first number of candidate media contents.

According to some embodiments of the present disclosure, an apparatus is provided for media content recommendation. The apparatus comprises: a providing module configured to provide, to a plurality of client devices, a first version of a ML model for media content recommendation; an obtaining module configured to obtain, from the plurality of client devices, updates to the ML model, an update from a client device being determined based respective interactions of a user with a first set of media content recommended by the first version; and an updating module configured to update the first version to a second version of the ML model based on the updates. Further, the apparatus may comprise other units for implementing other steps in the above method.

According to some embodiments of the present disclosure, an electronic device is provided for implementing the above method. The electronic device comprises: a computer processor coupled to a computer-readable memory unit, the memory unit comprising instructions that when executed by the computer processor implements a method for media content recommendation. The method comprises: providing, at a server to a plurality of client devices, a first version of a ML model for media content recommendation; obtaining, from the plurality of client devices, updates to the ML model, an update from a client device being determined based respective interactions of a user with a first set of media content recommended by the first version; and updating the first version to a second version of the ML model based on the updates.

In some embodiments of the present disclosure, the method further comprises obtaining, from a client device of the plurality of client devices, a metric for evaluating the ML model, the metric being determined based on respective interactions of the user with a second set of media contents recommended by the second version of the ML model.

In some embodiments of the present disclosure, the method further comprises selecting a first number of candidate media contents from a second number of candidate media contents; and providing, to the plurality of client devices, content information concerning the first number of candidate media contents.

According to some embodiments of the present disclosure, a computer program product, the computer program product comprising a computer readable storage medium having program instructions embodied therewith, the program instructions executable by an electronic device to cause the electronic device to perform the method 400.

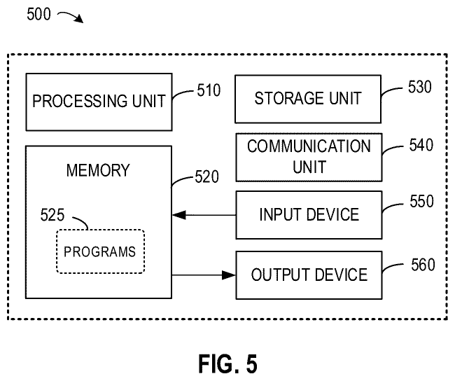

FIG. 5 illustrates a block diagram of a computing device 500 in which various embodiments of the present disclosure can be implemented. It would be appreciated that the computing device 500 shown in FIG. 5 is merely for purpose of illustration, without suggesting any limitation to the functions and scopes of the present disclosure in any manner. The computing device 500 may be used to implement the above methods 300 and 400. As shown in FIG. 5, the computing device 500 may be a general-purpose computing device. The computing device 500 may at least comprise one or more processors or processing units 510, a memory 520, a storage unit 530, one or more communication units 540, one or more input devices 550, and one or more output devices 560.

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller, or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk, or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem, and the like) enabling the computing device 500 to communicate with one or more other computing devices, if required. Such communication can be performed via input/output (I/O) interfaces (not shown).

In some embodiments, instead of being integrated in a single device, some, or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single implementation. Rather, various features described in a single implementation may also be implemented in multiple embodiments separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific embodiments of the presently disclosed technology have been described herein for purposes of illustration, but that various modifications may be made without deviating from the scope of the disclosure. Accordingly, the presently disclosed technology is not limited except as by the appended claims.

Embodiments of the subject matter and the functional operations described in the present disclosure can be implemented in various systems, digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular embodiments of particular disclosures. Certain features that are described in the present disclosure in the context of separate embodiments can also be implemented in combination in a single implementation. Conversely, various features that are described in the context of a single implementation can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments. Only a few embodiments and examples are described and other embodiments, enhancements and variations can be made based on what is described and illustrated in the present disclosure.

What is claimed is:

1. A method of training a model, comprising:
obtaining, at a client device from a server, a first version of a machine learning model for media content recommendation;
recommending, based on local information of the client device, a first set of media contents according to the first version of the machine learning model;
determining an update to the machine learning model based on respective interactions of the user with the first set of media contents; and
providing the update to the server.

2. The method of claim 1, wherein determining the update to the machine learning model comprises:
for a given media content in the first set of media contents,
assigning, to the given media content, a label corresponding to an interaction of the user with the given media content, the label indicating a degree of interest of the user in the given media content;
determining a difference between the label and a prediction of the given media content by the first version of the machine learning model; and
determining the update based on respective differences determined for the first set of media contents.

3. The method of claim 2, wherein the label is selected from the following:
a first label corresponding to a positive user interaction,
a second label corresponding to a negative user interaction.

4. The method of claim 2, wherein the label is selected from two or more of the following:
a third label corresponding to tagging a media content positively,
a fourth label corresponding to spreading of a media content,
a fifth label corresponding to commenting a media content,
a sixth label corresponding to ignoring a media content,
a seventh label corresponding to tagging a media content negatively.

5. The method of claim 2, wherein determining the difference is response to turning off a media content provision application utilizing the machine learning model.

6. The method of claim 1, wherein recommending the first set of media contents comprises:
obtaining, from the server, content information concerning a first number of candidate media contents, the first number of candidate media contents being selected from a second number of candidate media contents;
selecting the first set of media contents from the first number of candidate media contents by feeding the local information to the machine learning model; and
presenting an indication of the first set of media contents.

7. The method of claim 1, further comprising:
obtaining, from the server, a second version of the machine learning model, the second version being updated from the first version at least based on the update and a further update provided by a further client device.

8. The method of claim 7, further comprising:
recommending, based on the local information, a second set of media contents according to the second version of the machine learning model;
determining a metric for evaluating the machine learning model based on respective interactions of the user with the second set of media contents; and
providing the metric to the server.

9. An electronic device, comprising a computer processor coupled to a computer-readable memory unit, the memory unit comprising instructions that when executed by the computer processor implements a method for media content recommendation, the method comprising:
obtaining, from a server, a first version of a machine learning model for media content recommendation;
recommending, based on local information of the electronic device, a first set of media contents according to the first version of the machine learning model;
determining an update to the machine learning model based on respective interactions of the user with the first set of media contents; and
providing the update to the server.

10. The device of claim 9, wherein determining the update to the machine learning model comprises:
for a given media content in the first set of media contents,
assigning, to the given media content, a label corresponding to an interaction of the user with the given media content, the label indicating a degree of interest of the user in the given media content;
determining a difference between the label and a prediction of the given media content by the first version of the machine learning model; and
determining the update based on respective differences determined for the first set of media contents.

11. The device of claim 10, wherein the label is selected from the following:
a first label corresponding to a positive user interaction,
a second label corresponding to a negative user interaction.

12. The device of claim 10, wherein the label is selected from two or more of the following:
a third label corresponding to tagging a media content positively,
a fourth label corresponding to spreading of a media content,
a fifth label corresponding to commenting a media content,
a sixth label corresponding to ignoring a media content,
a seventh label corresponding to tagging a media content negatively.

13. The device of claim 10, wherein determining the difference is response to turning off a media content provision application utilizing the machine learning model.

14. The device of claim 9, wherein recommending the first set of media contents comprises:
obtaining, from the server, content information concerning a first number of candidate media contents, the first number of candidate media contents being selected from a second number of candidate media contents;
selecting the first set of media contents from the first number of candidate media contents by feeding the local information to the machine learning model; and
presenting an indication of the first set of media contents.

15. The device of claim 9, wherein the method further comprises:
obtaining, from the server, a second version of the machine learning model, the second version being updated from the first version at least based on the update and a further update provided by a further client device.

16. The device of claim 7, wherein the method further comprises:
recommending, based on the local information, a second set of media contents according to the second version of the machine learning model;
determining a metric for evaluating the machine learning model based on respective interactions of the user with the second set of media contents; and
providing the metric to the server.

17. A computer program product, the computer program product comprising a non-transitory computer readable storage medium having program instructions embodied therewith, the program instructions executable by an electronic device to cause the electronic device to perform a method for media content recommendation, the method comprises:
obtaining a first version of a machine learning model for media content recommendation;
recommending, based on local information of the electronic device, a first set of media contents according to the first version of the machine learning model;
determining an update to the machine learning model based on respective interactions of the user with the first set of media contents; and
providing the update to the server.

18. The computer program product of claim 17, wherein determining the update to machine learning model comprises:
for a given media content in the first set of media contents,
assigning, to the given media content, a label corresponding to an interaction of the user with the given media content, the label indicating a degree of interest of the user in the given media content;
determining a difference between the label and a prediction of the given media content by the first version of the machine learning model; and
determining the update based on respective differences determined for the first set of media contents.

19. The computer program product of claim 17, wherein recommending the first set of media contents comprises:
obtaining, from the server, content information concerning a first number of candidate media contents, the first number of candidate media contents being selected from a second number of candidate media contents;
selecting the first set of media contents from the first number of candidate media contents by feeding the local information to the machine learning model; and
presenting an indication of the first set of media contents.

20. The computer program product of claim 17, wherein the method further comprises:
obtaining, from the server, a second version of the machine learning model, the second version being updated from the first version at least based on the update and a further update provided by a further client device.
